(19) United States
(12) Patent Application Publication
(10) Pub. No.: US 2015/0139804 A1
(43) Pub. Date: May 21, 2015

(54) FLOW-BASED POWER GENERATING PLANT WITH TWIST BEARING IN THE BLADE ROOT

(71) Applicant: SCHOTTEL GMBH, Spay/Rhein (DE)

(72) Inventors: Martin Baldus, Rotenhain (DE); Efim Groh, Koblenz (DE); Gerhard Jensen, Beulich (DE)

(21) Appl. No.: 14/413,201

(22) PCT Filed: Jul. 4, 2013
(86) PCT No.: PCT/EP2013/064127

§ 371 Date: Jan. 6, 2015

(30) Foreign Application Priority Data
Jul. 6, 2012 (DE) 10 2012 106 099.1

(51) Int. Cl. F03D 11/00

(52) U.S. Cl. CPC F03D 11/0008
USPC 416/174; 415/229

(57) ABSTRACT

A flow-based power generating plant with a turbine, which can be acted on by a fluid flow and having a plurality of blades that extend from a blade base to a blade tip and are fastened by the blade base to a rotating rotor. The action of the fluid flow can cause the blades to twist elastically around an axis which extends through the blade base, in such a way that the pitch of the blades can be increased. The blade base is fastened to the rotor with the interposition of a bearing device and the bearing device is embodied as rigid in terms of tension, compression, bending, and shearing relative to the axis, but is embodied as flexible in terms of torsion, wherein the bearing device has a primary connecting part fastened to the rotor and a secondary connecting part fastened to the blade base, which are connected to each other via a multitude of leaf springs so that the primary connecting part is able to rotate relative to the secondary connecting part through elastic deformation of the leaf springs and the leaf springs are arranged on an essentially circular circumference and have a rectangular cross-section with a longer side and a shorter side, with the longer side extending radially outward with regard to the circumference on which the leaf springs are arranged.

### BACKGROUND OF THE INVENTION

1. Field of the Invention

This invention relates to a flow-based power generating plant with a turbine, which can he acted on by a fluid flow and has a plurality of blades that extend from a blade base to a blade tip and are fastened by the blade base to a rotating rotor, the action of the fluid flow can cause the blades to twist elastically around an axis which extends through the blade base so that the pitch of the blades can be increased, and the blade base is fastened to the rotor with the interposition of a bearing device and the bearing device is formed as rigid in terms of tension, compression, bending, and shearing relative to the axis, but formed as flexible in terms of torsion.

2. Discussion of Related Art

Flow-based power generating plants are known and themselves can, for example, when embodied as wind power plants or hydroelectric power plants, be acted on by the flow of a corresponding fluid, such as a wind or water current, in order to generate electrical energy through rotation of the rotor inside the turbine.

In flow turbines of this kind, such as axial through-flow tidal power plants or wind turbine generator systems, however, in addition to the desirable torques, undesirable shear forces also occur, which must be conveyed through the structural components into the foundation, entailing high construction costs. Particularly with high flow speeds of the fluid flowing against them that exceed the nominal operating point, it becomes necessary to take suitable steps to limit the shear forces and also the input power of the flow-based power generating plant.

One kind of shear and power limitation is a so-called stall control. In this case, the turbine is slowed until the incoming flow situation causes a stall at the blades.

Another method that has now become frequent and widespread is a so-called pitch control. In this case, the forces and moments occurring are limited by rotating the blades, for example by an adjusting mechanism, into a position with a higher pitch and in this way, the angle of attack is reduced, thus reducing the energy drawn from the fluid flow. Adjusting mechanisms for turbine blades are generally composed of a bearing, which is embodied in the form of a roller bearing or slide bearing, and a drive, which moves the blade into the desired position with an electrical or hydraulic energy supply. In addition to the susceptibility to malfunction and the high construction cost, the disadvantage of this embodiment is the inevitable wear on bearings and drive components, making it necessary to perform frequent maintenance procedures that should absolutely be avoided, however, particularly in hard-to-reach offshore systems.

German Patent Reference DE 30 17 886 A1 discloses a bearing device, which has a torsionally flexible torsion bar with the greatest possible overall length and a hydraulic adjusting damper. The device is difficult to configure and due to the adjusting damper, is maintenance-intensive.

Great Britain Patent Reference GB 1 534 779 A discloses attaching the blade to the hub via a torsion spring whose one end is clamped in bearing bushings. This type of connection is flexible and also susceptible to wear in the region of the bearing bushings.

### SUMMARY OF THE INVENTION

One object of this invention is to provide a flow-based power generating plant of the type mentioned above but in which the blade adjustment is as wear-free as possible and, without a separate supply of electrical or hydraulic energy, is drawn solely from the available fluid flow.

In order to attain the stated object, this invention provides a flow-based power generating plant with the features related to embodiments and modifications of this invention as described in this invention and in the claims.

This invention provides attaching the blades to the rotor by the bearing device so that the normal forces, transverse forces, and bending moments exerted on the blade by the fluid flow due to the given geometry of the blade are transmitted to the rotor with the least possible deformation of the bearing device and at the rotor, are converted into the inherently desired rotation for the generation of electrical energy, whereas torques that occur around the rotation axis of the blade that correlate with the intensity of the fluid flow result in the desired torsion of the blade around the torsion axis and by the increase in the blade pitch that occurs, and automatically limit the power consumption thereof.

An overloading of the turbine, for example in unfavorable weather conditions, is thus automatically prevented without requiring a regulating device and the supply of separate electrical or hydraulic energy to the flow-based power generating plant.

According to this invention, the bearing device has a primary connecting part fastened to the rotor and a secondary connecting part fastened to the blade base, which are connected to each other via a multitude of leaf springs in such a way that the primary connecting part is able to rotate relative to the secondary connecting part through elastic deformation of the leaf springs. Through suitable orientation and dimensioning of the leaf springs, it is then possible to achieve the fact that between the primary connecting part and the secondary connecting part, the desired rigidity exists in terms of tension, compression, bending, and shearing, but the desired torsional flexibility is present so that the primary connecting part and the secondary connecting part can twist relative to each other and as a result, the blade fastened to the secondary connecting part can be elastically twisted in order to increase its pitch when it is struck by an appropriately powerful fluid flow.

According to this invention, the leaf springs are arranged on an essentially circular circumference and have a rectangular cross-section with a longer side and a shorter side, with the longer side extending radially outward with regard to the circumference on which the leaf springs are arranged. Due to this orientation, all of the leaf springs have only a low area moment of inertia in the circumference direction and in this regard, behave in a torsionally flexible fashion, whereas in the radial direction, they have a high area moment of inertia and contrary to the permissible high torsional movements, only have small shear deformations, bending angles, and longitudinal extensions and compressions. An elastic bending of the blade due its being acted on by the flow of the fluid is consequently divided into tensile and compressive forces in the region of the bearing device and is transmitted to the rotor practically without elastic deformation of the leaf springs and to the remaining structure of the flow-based power generating plant.

According to one embodiment of this invention, the leaf springs are embodied congruently and are spaced at regular distances apart from one another in order to implement a uniform load-absorbing behavior over the entire bearing device.

According to one embodiment of this invention, the primary connecting part is connected to the secondary connecting part with the interposition of the leaf springs. Again, it is possible for the leaf springs to have a linear axial span with one end fastened to the primary connecting part and the other opposite end fastened to the secondary connecting part.

In addition to the arrangement of leaf springs along a circumference, it is also possible for the primary connecting part and secondary connecting part to be aligned concentric to each other and for the leaf springs to each include a plurality of sub-springs that are arranged on circumferences, which are concentric to each other, and are connected to one another by an intermediate ring. The one set of sub-springs are connected to the primary connecting part and the other sub-springs are connected to the secondary connecting part.

Alternatively, it is also possible for the primary connecting part and the secondary connecting part to be arranged concentric to each other and for the leaf springs to have an approximately U-shaped design with two leg ends, of which one leg end is connected to the primary connecting part and the other leg end is connected to the secondary connecting part. In another embodiment, the blade base can, for example, be embodied as hollow and its inner cavity can encompass the leaf springs that protrude from the primary connecting part and secondary connecting part.

In each of the above-mentioned exemplary embodiments, however, the leaf springs used are each clamped in the primary connecting part and the secondary connecting part rigidly in terms of moment.

It is also possible to provide end stops between the primary connecting part and the secondary connecting part, which limit the ability of the latter components to rotate relative to each other and to this extent, define the starting and end points of a working range of the bearing device according to this invention. With this, it is possible, for example, to limit the maximum elastic twisting of the blade and thus the maximum increase in the blade pitch because the end stop is reached, which defines the end point of the working range.

It is also possible that at the starting point of the working range, the leaf springs are already elastically prestressed so that a further twisting of the blades that increases their pitch only occurs after the elastic restoring forces of the leaf springs, which are set by the prestressing, have been overcome. In this respect, it is possible, through appropriate dimensioning of the leaf springs used and through the prestressing of them, to allow a blade adjustment in the sense of an increase in blade pitch only if the fluid flow acting on the flow-based power generating plant exceeds a correspondingly predeterminable threshold value, whereas if it falls below this threshold value, no appreciable increase in the blade pitch takes place so that until a predeterminable nominal operating point is reached, the flow-based power generating plant according to this invention can operate with the maximum energy yield from the fluid flow by optimized blade adjustment.

According to one embodiment of this invention, the leaf springs are preferably made of anisotropic materials, which can include, for example, metals such as appropriate spring steels, but also suitable fiber composite materials.

### BRIEF DESCRIPTION OF THE DRAWINGS

Other embodiments and details of this invention are explained in greater detail in view of the drawings, wherein:

FIG. 1 shows a front view of a flow-based power generating plant according to this invention;

FIG. 2 shows a side view of the flow-based power generating plant according to FIG. 1;

FIG. 3 shows a view of a rotor of the flow-based power generating plant according to FIG. 1, in an enlarged depiction;

FIG. 4a shows a perspective view of one embodiment of a bearing device according to this invention;

FIG. 4b shows a side view of the bearing device according to FIG. 4a;

FIG. 4c shows a top view of the bearing device according to FIG. 4a;

FIG. 5a shows a blade of the flow-based power generating plant according to this invention, in a non-deformed state;

FIG. 5b shows the blade according to FIG. 5a, in a deformed state;

FIG. 6a shows a top view of the bearing device of the blade according to FIG. 5a;

FIG. 6b shows a top view of the hearing device of the blade according to FIG. 5b;

FIG. 7 shows a detail of the bearing device according to FIG. 6a;

FIG. 8 shows another embodiment of a bearing device according to this invention; and

FIG. 9 shows another embodiment of a hearing device according to this invention.

### DETAILED DESCRIPTION OF THE INVENTION

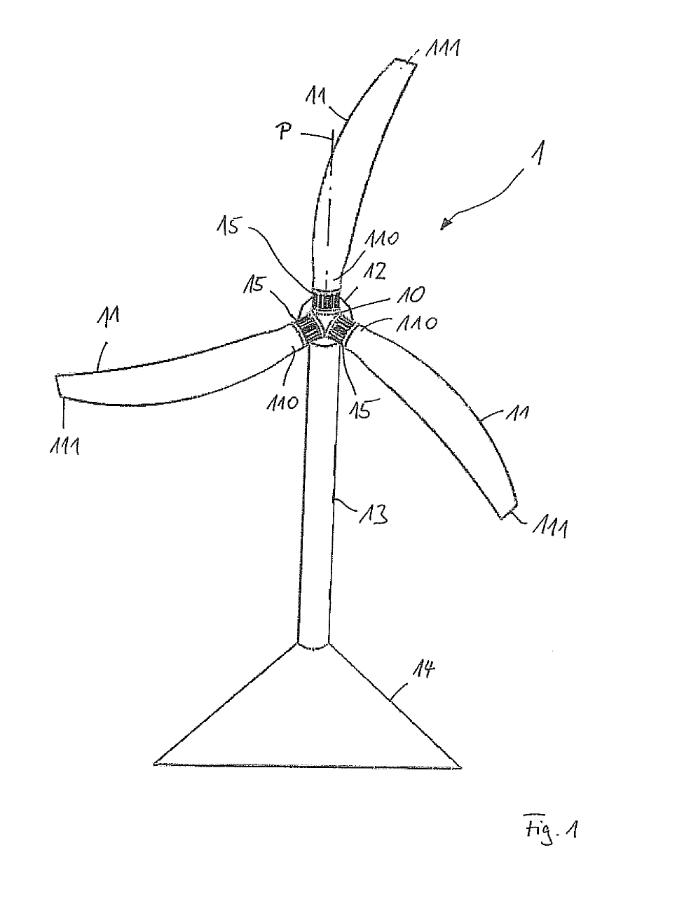

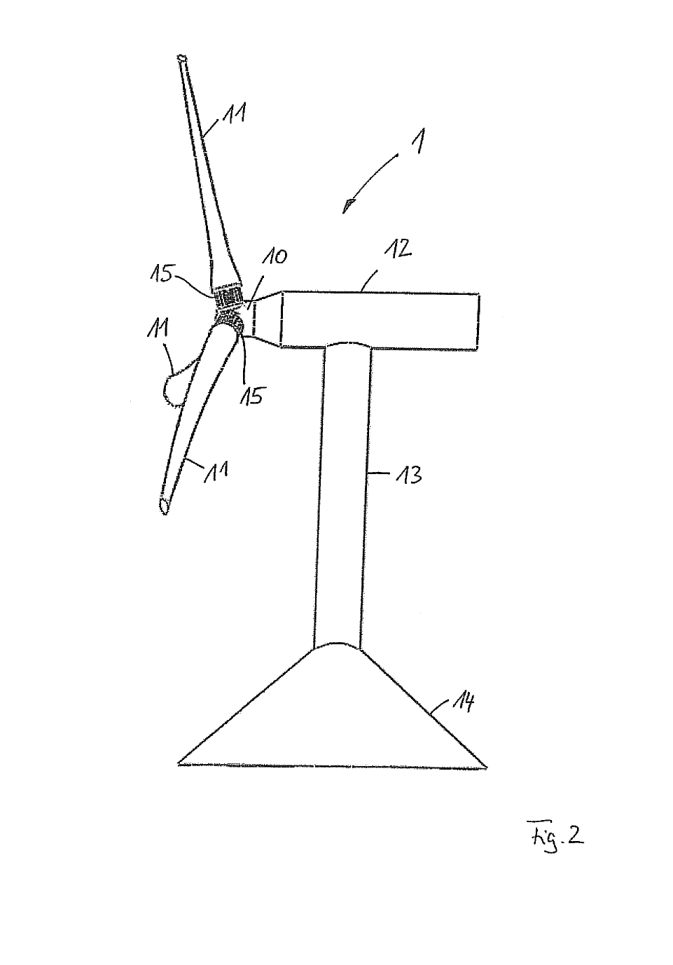

FIGS. 1 and 2 show a flow-based power generating plant 1, which can be acted on by a water current when embodied as a tidal power plant or can be acted on by an air current when embodied as a wind turbine generator system. Starting from a foundation 14, the flow-based power generating plant 1 includes a vertically extending mast 13 with an upper end equipped with a turbine 12 that has a rotor 10, which can be set into rotation in an intrinsically known fashion by the blades 11 when they are acted on by the current and can drive a generator situated inside the turbine 12 to generate electrical energy.

As shown in FIG. 3, the respective blade base 110 of the blade 11 that extends all the way to a blade tip 111 is fastened to the rotor 10 via a bearing device labeled with the reference numeral 15, in order to achieve the desired energy conversion from the fluid flow into the rotation of the rotor 10.

The bearing devices 15 in this case include a primary connecting part 150 embodied in the form of a round disk and fastened to the rotor 10 and a secondary connecting part 152 likewise embodied in the form of a round disk and fastened to the blade base 110, which parts are held spaced apart from each other and connected to each other by a multitude of leaf springs 151 that are described in greater detail below.

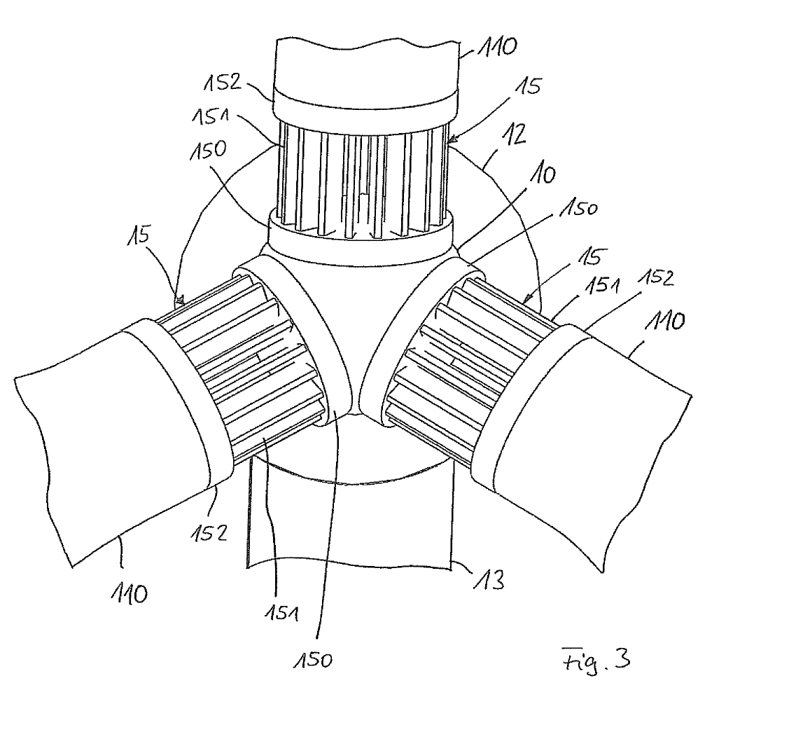

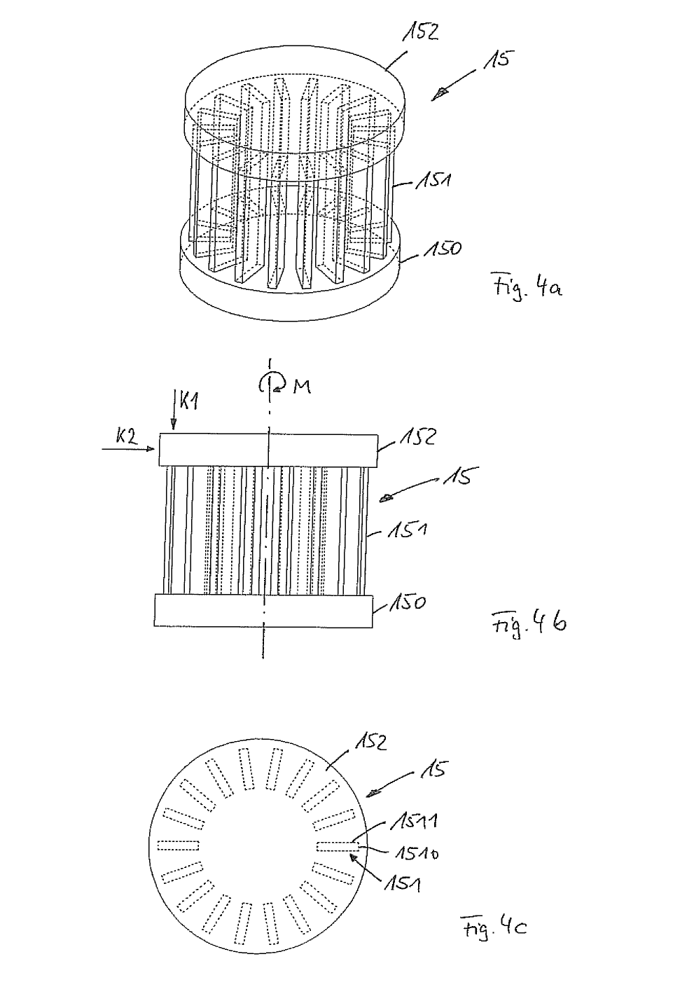

As is particularly evident when considering FIGS. 4a through 4c together, the leaf springs 151 are all embodied congruently and are spaced apart from one another at regular distances along a circular circumference. They are each anchored with their respective ends in the primary connecting part 150 and secondary connecting part 152, respectively, in a rigid fashion in terms of moment.

The individual leaf springs 151 function as bending rods and to this end, are embodied with a rectangular cross-section, with a short side 1510 and a side 1511 that is significantly longer than the short side, in this case four to five times longer than it, and oriented so that the longer side extends radially outward with regard to the circumference on which the leaf springs 151 are arranged.

This orientation of the leaf springs 151, which can be made, for example, of a suitable anisotropic material such as spring steel or suitable fiber composite materials, achieves the fact that these exerted forces, like the forces labeled K1 and K2 in FIG. 4b, are opposed by a high area moment of inertia and correspondingly high resistance, but the exerted moments according to arrow M around the vertical axis are opposed by only an extremely low area moment of inertia and consequently give the bearing device 15 the characteristic of being embodied as rigid in terms of tension, compression, bending, and shearing, but flexible in terms of torsion.

The use of such a bearing device 15 in the connecting region between the base 110 of the blade 11 and the rotor 10 that is driven to rotate by it achieves the fact that the blades 11, due to the action of the fluid flow, can be elastically twisted around an axis P, which is visible for example in FIG. 1 and extends through the blade base 110, in such a way that with increasing fluid flow, the pitch of the blades can be increased in order to limit the power consumption of the blade.

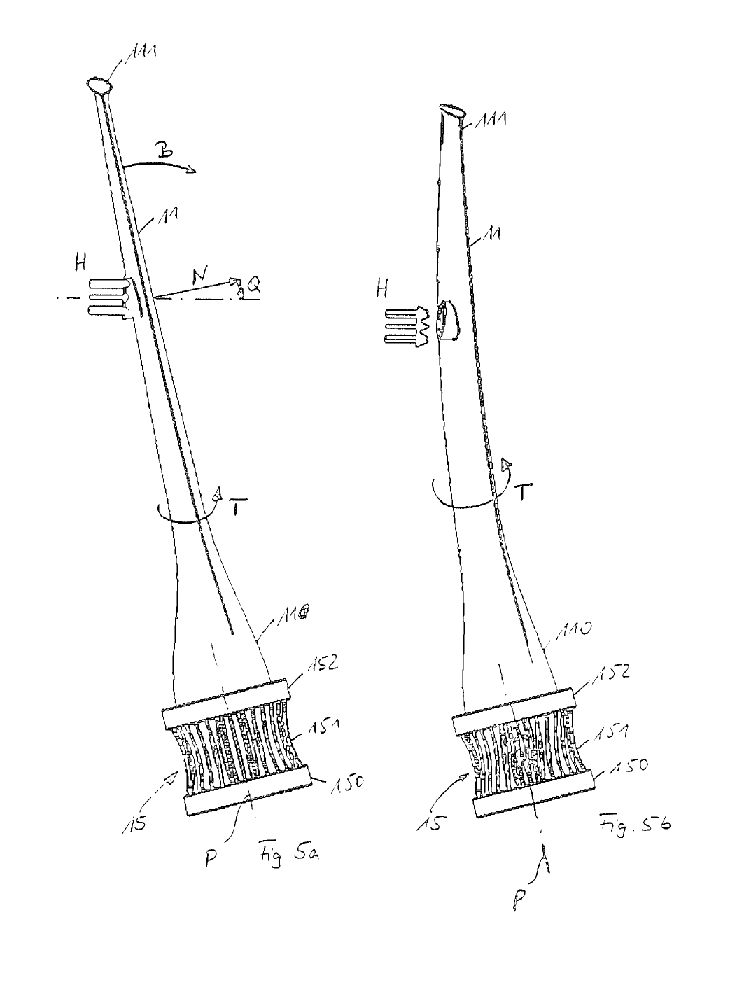

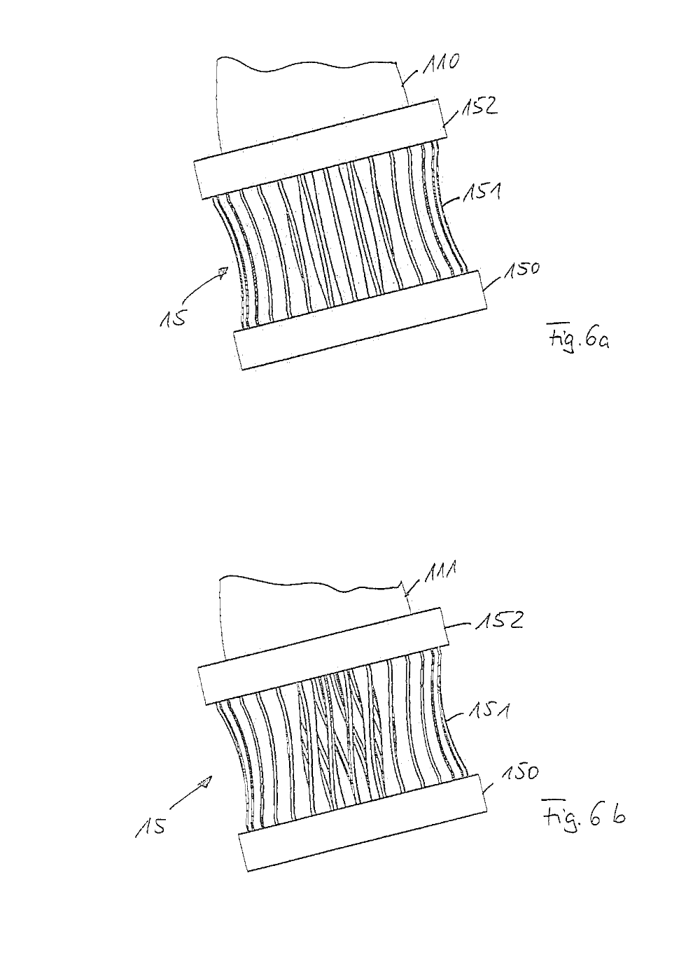

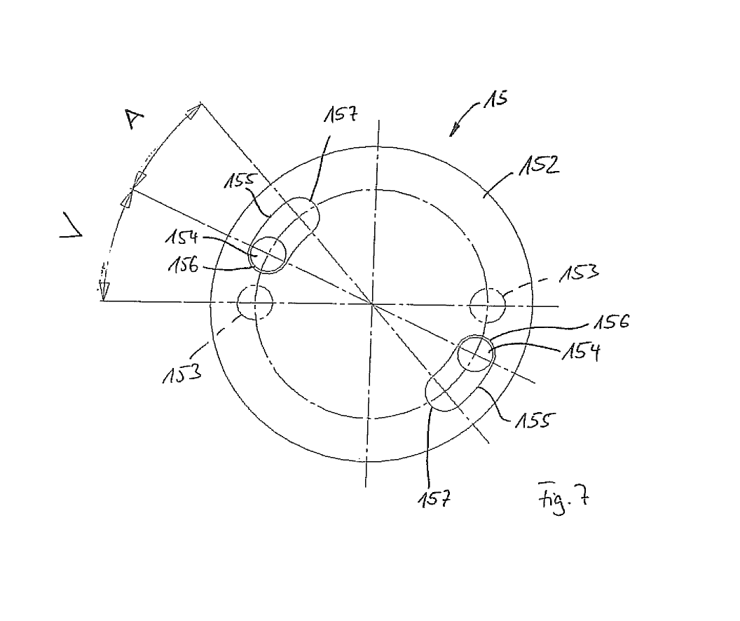

This is evident from a comparison of the depictions in FIGS. 5a and 5b to the corresponding FIGS. 6a and 6b.

FIG. 5a and the associated enlarged depiction of the bearing device 15 according to FIG. 6a show a blade 11 that is being acted on by only a weak fluid flow H or none at all. The normal forces N, associated transverse forces Q, torsion moments T, and possible bending moments B that act on the blade 11 and are produced by the at most weak flow against the blade profile of the blade 11 due to the flow H generate forces that are represented by the forces K1, K2 in the depiction according to FIG. 4b and because of the characteristic embodiment of the bearing device 15 as rigid in terms of tension, compression, bending, and shearing, are introduced from it without deformation of any consequence, from the secondary connecting part 152 via the leaf springs 151 and the primary connecting part 150, and into the rotor 10 (not shown). The enlarged depiction according to FIG. 6a shows that the leaf springs 151 do not experience deformation of any consequence during this since they oppose these occurring forces with their high area moments of inertia due to their characteristic orientation as explained above.

But if the fluid flow increases, then in addition to the forces already explained in conjunction with FIG. 5a, this flow according to arrow H also generates moments T according to FIG. 5b, which the bearing device 15, due to its torsionally flexible embodiment, is unable to oppose with any sufficiently high resistance and in this respect, the leaf springs 151 can be deformed relatively easily in reaction to these powerful torsion moments T acting on them, as is particularly evident from the depiction according to FIG. 6b so that a relative torsion occurs between the primary connecting part 150 and the secondary connecting part 152 around the axis P according to FIG. 1. As a result, the pitch of the blade 11 that has been rotated around its axis P in this way increases so that the correlating power consumption from the fluid flow H is reduced since the attack angle is correspondingly increased. This torsion of the blade 11 is elastic since the leaf springs 151 produce a corresponding restoring moment and for this reason, the blade 11 is also rotated back into its original or starting position according to FIG. 5a as soon as the fluid flow H has sufficiently abated.

In other words, a powerful load due to powerful fluid flow H does in fact lead to the occurrence of powerful normal forces N, transverse forces Q, bending moments B, and torsion moments T, but these powerful forces only result in a significant torsion of the bearing device 15 in the direction of the torsion moment T.

This achieves the desired adjustment of the blades, which occurs automatically and functions without an additional supply of energy, in order to limit the power consumption of the flow-based power generating plant and protect it from overload.

Naturally, as shown in FIG. 2, the longitudinal axis of the bearing of the blades 11 can have an axial angle of less than 90° relative to the main rotation axis of the rotor 10 in order, in combination with the center of gravity of the blade outside of the longitudinal axis of the bearing, to produce a torque resulting from centrifugal force, which torque encourages the above-explained twisting or torsion in the region of the bearing device 15.

In the same way, the longitudinal axis of the bearing can be embodied as different from the profile-generating axis of the blade in order to produce a torque generated by the hydrodynamic loads, which torque likewise encourages the desired torsional twisting of the blade.

In a modification of this invention, between the primary connecting part 150 and the secondary connecting part 152, end stops are provided, which limit their ability to twist relative to each other.

Thus it is possible, for example, to provide the secondary connecting part 152 with oblong holes 155, as shown in FIG. 7, in which a pin 154 that is thinly clamped in the primary connecting part, not shown here, is guided. The respective end regions of the oblong holes 155 then define the end stops 156 and 157, which simultaneously define the starting point and end point of a working range A of the bearing device 15. In the exemplary embodiment shown according to FIG. 7, the end stop 156 defines the starting point of the working range A and the end stop 157 defines the end point of the working range A. As soon as the end stop 157 is reached, this limits a further twisting of the blade in the direction of even greater blade pitch so that it is possible to limit the elastic rotation of the blade 11 that is enabled by the bearing device according to this invention.

An embodiment according to FIG. 7 also permits a predeterminable prestressing of the leaf springs 152 if the starting point of the working range A, which is defined by the first end stop 156, does not coincide with the relaxed position of the leaf springs 151 shown in FIG. 6a, in which the pin 154 would actually have to he in the position depicted according to reference numeral 153. In the exemplary embodiment shown here, at the starting point of the working range, the pin 154 is already twisted by the angle V in the rotation direction in which the blade should also be twisted due to the flow H acting on it, such as the leaf springs 151 are correspondingly prestressed and act on the primary connecting part 150 and the secondary connecting part 152 with corresponding restoring forces. The end stop 156 against which the pin 154 rests, however, prevents the leaf springs 151 from relaxing completely.

The magnitude of this prestressing force of the leaf springs can be easily adapted to the respective conditions through the determination of the angle V.

In a bearing device 15 that is prestressed in this way, torques T acting on the blade 11 result in a further twisting of the blade in the direction of an increased pitch only when these torques exceed the restoring forces of the leaf springs 151 that are produced because of the prestressing V. It is thus possible to define a threshold value, which is predeterminable and depends on the restoring forces of the leaf springs 151, up to which the blades 11 do not experience any twisting due to the fluid flow and thus draw energy from the fluid flow with an optimal blade geometry and only when this threshold value is exceeded does the desired power-limiting adjustment of the blades 11 in the direction of a greater pitch occur in order to prevent mechanical damage and overloads. A flow-based power generating plant that functions in this way can excel due to its extremely high efficiency.

In lieu of the embodiment of a bearing element 15 with leaf springs 151 extending radially outward and arranged on a circumference, as shown in FIGS. 4a through 4c, other embodiments are also possible within the scope of this invention.

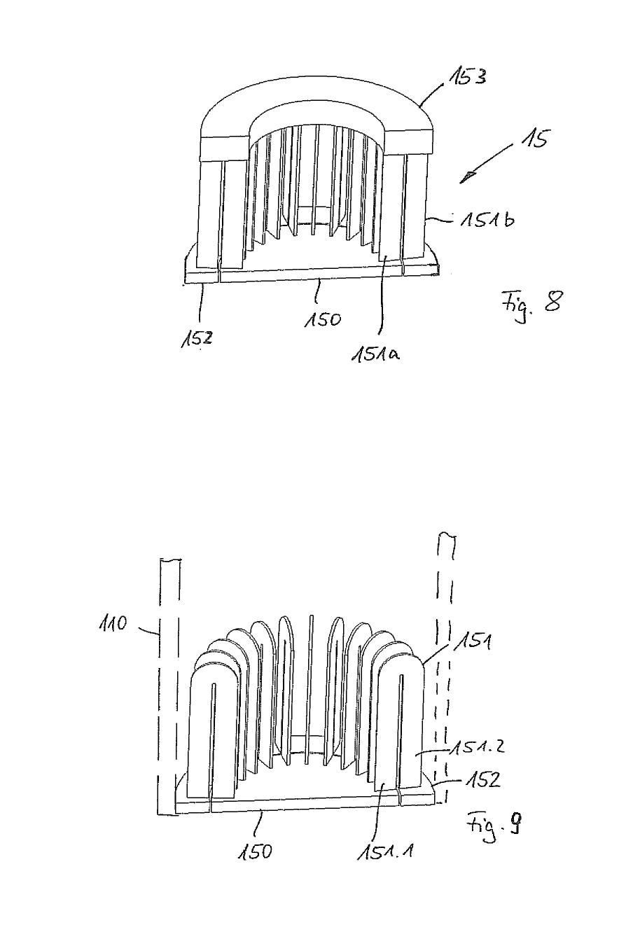

FIG. 8 shows a bearing element 15 in which each leaf spring 151 is respectively composed of or comprises two sub-springs 151a, 151b situated one after the other in the radial direction. An intermediate ring 153, which connects the sub-springs 151a, 151b, achieves a series connection of the sub-springs 151a, 151b, which results in a reduced torsional rigidity.

In the exemplary embodiment shown here, the sub-springs 151a, 151b and the primary connecting part 150 and the secondary connecting part 152 are situated concentric to one another in order to implement the reduced torsional rigidity in a comparatively small amount of space. In this instance, the blade base 110, as shown with dashed lines, is embodied as hollow and accommodates the leaf springs 151, which protrude vertically beyond the primary connecting part 150 and secondary connecting part 152, in its cavity and is connected to the secondary connecting part 152 in a suitable fashion.

FIG. 9 shows another possible embodiment of a bearing device 15 in which the primary connecting part 150 and the secondary connecting part 152 are not held spaced apart from each other through the interposition of the leaf springs 151. Instead, they are arranged concentric to each other, such as the primary connecting part 150 is embodied as a circular disc and is encompassed by the annular secondary connecting part 152 arranged concentric to it. The leaf springs 151 in this case have an upside-down U-shaped design and have two leg ends 151.1 and 151.2, of which the one leg 151.1 engages with the primary connecting part 150 and the other leg 151.2 engages with the secondary connecting part 152. Also in this case, the blade base 110, as shown with dashed lines, is embodied as hollow and accommodates the leaf springs 151, which protrude vertically beyond the primary connecting part 150 and secondary connecting part 152, in its cavity and is connected to the secondary connecting part 152 in a suitable fashion.

Depending on the specific use, it is also possible to provide different arrangements of the leaf springs 151 between the primary connecting part 150 and the secondary connecting part 152.

With the flow-based power generating plant explained above, it is possible to support the blades in a wear-free, elastic fashion and to adjust them within their operating range. The energy required for the adjustment is drawn exclusively from the hydrodynamic shear forces and/or from the centrifugal forces of the blades without a supply of electrical or hydraulic energy, which allows these long-unwanted, but inevitable forces to perform a useful function.

1. A flow-based power generating plant (1) with a turbine, which can be acted on by a fluid flow (H) and having a plurality of blades (11) that extend from a blade base (110) to a blade tip (111) and fastened by blade base (110) to a rotating rotor (10); an action of the fluid flow (H) can cause the blades (11) to twist elastically around an axis (P), which extends through the blade base (110) so that a pitch of the blades can be increased; the blade base (111) is fastened to the rotor (10) with an interposition of a bearing device (15) and the bearing device is rigid in tension, compression, bending, and shearing relative to the axis (P) and is flexible in torsion, the flow-based power generating plant comprising: the bearing device (15) having a primary connecting part (150) fastened to the rotor (10) and a secondary connecting part (152) fastened to the blade base (110) which are connected to each other by a multitude of leaf springs (151) so that the primary connecting part (150) can rotate relative to the secondary connecting part (152) through elastic deformation of the leaf springs (151) and the leaf springs (151) are arranged on an essentially circular circumference and have a rectangular cross-section with a longer side and a shorter side (1511, 1510), with the longer side (1511) extending radially outward with respect to a circumference on which the leaf springs (151) are arranged.

2. The flow-based power generating plant (1) according to claim 1, wherein the leaf springs (151) a congruent and are spaced at regular distances apart from one another.

3. The flow-based power generating plant (1) according to claim 2, wherein the primary connecting part (150) is connected to the secondary connecting part (152) with an interposition of the leaf springs (151).

4. The flow-based power generating plant (1) according to claim 3, wherein the primary connecting part (150) and the secondary connecting part (152) are aligned concentric to each other and the leaf springs (151) each includes a plurality of sub-springs (151a, 151b) arranged on circumferences concentric to each other, and are connected to one another by an intermediate ring (153), with the sub-springs (151a) connected to the primary connecting part (150) and the sub-springs (151b) connected to the secondary connecting part (152).

5. The flow-based power generating plant (1) according to claim 3, wherein the primary connecting part (150) and the secondary connecting part (152) are arranged concentric to each other and the leaf springs (151) have an approximately U-shaped design with leg ends (151.1, 151.2), of which one leg end (151.1) is connected to the primary connecting part (150) and an other leg end (151.2) is connected to the secondary connecting part (152).

6. The flow-based power generating plant (1) according to claim 5, wherein end stops (156, 157) are provided between the primary connecting part (150) and the secondary connecting part (152), which limit twisting relative to each other and define a starting point and an end point of a working range (A) of the bearing device (15).

7. The flow-based power generating plant (1) according to claim 6, wherein at the starting point of the working range (A), the leaf springs (151) are elastically prestressed.

8. The flow-based power generating plant (1) according to claim 7, wherein the leaf springs (151) are of anisotropic materials.

9. The flow-based power generating plant (1) according to claim 1, wherein the primary connecting part (150) is connected to the secondary connecting part (152) with an interposition of the leaf springs (151).

10. The flow-based power generating plant (1) according to claim 9, wherein the primary connecting part (150) and the secondary connecting part (152) are aligned concentric to each other and the leaf springs (151) each includes a plurality of sub-springs (151a, 151b) arranged on circumferences concentric to each other, and are connected to one another by an intermediate ring (153), with the sub-springs (151a) connected to the primary connecting part (150) and the sub-springs (151b) connected to the secondary connecting part (152).

11. The flow-based power generating plant (1) according to claim 1, wherein the primary connecting part (150) and the secondary connecting part (152) are arranged concentric to each other and the leaf springs (151) have an approximately U-shaped design with leg ends (151.1, 151.2), of which one leg end (151.1) is connected to the primary connecting part (150) and an other leg end (151.2) is connected to the secondary connecting part (152).

12. The flow-based power generating plant (1) according to claim 1, wherein end stops (156, 157) are provided between the primary connecting part (150) and the secondary connecting part (152), which limit twisting relative to each other and define a starting point and an end point of a working range (A) of the bearing device (15).

13. The flow-based power generating plant (1) according to claim 12, wherein at the starting point of the working range (A), the leaf springs (151) are elastically prestressed.

14. The flow-based power generating plant (1) according to claim 1, wherein the leaf springs (151) are of anisotropic materials.
